(19) United States
(12) Patent Application Publication
(10) Pub. No.: US 2016/0021230 A1
(43) Pub. Date: Jan. 21, 2016

(54) COMMUNICATION APPARATUS CONNECTABLE WITH EXTERNAL APPARATUS BY WIRELESS COMMUNICATION, METHOD FOR CONTROLLING COMMUNICATION APPARATUS, AND STORAGE MEDIUM

(71) Applicant: CANON KABUSHIKI KAISHA, Tokyo (JP)

(72) Inventor: Kenta Watanabe, Kawasaki-shi (JP)

(21) Appl. No.: 14/798,070

(22) Filed: Jul. 13, 2015

(30) Foreign Application Priority Data
Jul. 16, 2014 (JP) 2014-146011

(51) Int. Cl. H04M 1/725; H04W 4/00; H04N 5/44

(52) U.S. Cl. CPC H04M 1/7253; H04N 5/44; H04W 4/008; H04W 84/12

(57) ABSTRACT

A communication apparatus includes a sharing unit that shares a plurality of communication parameters for connecting to an external apparatus via a first communication with the external apparatus via a second communication different from the first communication, and a connection unit that connects to the external apparatus via the first communication using the shared plurality of communication parameters, wherein the sharing unit shares a first communication parameter of the plurality of communication parameters with a higher priority over a second communication parameter, wherein the first communication parameter is information for joining a same network with the external apparatus via the first communication, and wherein the second communication parameter is information for communicating with the external apparatus in the network via the first communication.

### BACKGROUND

1. Field

Aspects of the present invention generally relate to a communication apparatus connectable with an external apparatus by wireless communication.

2. Description of the Related Art

Digital cameras that can connect to a mobile phone via wireless communication and exchange image data have recently been known. To omit part of a procedure in which the user needs to make operations for the connection via wireless communication, a technique (handover) for sharing communication parameters required for the connection via wireless communication by using other wireless communication has also been known. For example, Japanese Patent Application Laid-Open No. 2013-157736 discusses sharing communication parameters with which apparatuses are connected to each other via a wireless local area network (LAN) by using near field communication (NFC).

Close-proximity wireless communications such as NFC discussed in Japanese Patent Application Laid-Open No. 2013-157736 have an advantage that, unlike a wireless LAN and Bluetooth (registered trademark), communication can be performed by simply putting the devices into close proximity to each other to perform communications. In close-proximity wireless communications, a communication path is maintained by the user putting the devices in a close positional relationship. An appropriate positional relationship may thus fail to be maintained depending on the manner how the user holds the devices and the action by which the devices are put into close proximity. If an appropriate positional relationship is lost during data exchange and the communication is disconnected, data to be recorded can be damaged. In such a case, because of the data damage, data needed for the handover fails to be correctly read and the handover becomes unable to be performed at least only by the action of putting the devices in close proximity.

### SUMMARY

Aspects of the present invention are generally directed to a communication apparatus capable of reducing the possibility of a handover failure due to failed data exchange by close-proximity wireless communication.

According to an aspect of the present invention, a communication apparatus includes a sharing unit configured to share a plurality of communication parameters for connecting to an external apparatus via a first communication with the external apparatus via a second communication different from the first communication, and a connection unit configured to connect to the external apparatus via the first communication using the shared plurality of communication parameters, wherein the sharing unit is configured to share a first communication parameter of the plurality of communication parameters with a higher priority over a second communication parameter, wherein the first communication parameter is information for joining a same network with the external apparatus via the first communication, and wherein the second communication parameter is information for communicating with the external apparatus in the network via the first communication.

According to the present disclosure, the possibility of a handover failure due to failed data exchange by close-proximity wireless communication can be reduced.

Further features of the present disclosure will become apparent from the following description of exemplary embodiments with reference to the attached drawings.

### BRIEF DESCRIPTION OF THE DRAWINGS

FIG. 1A is a block diagram illustrating a configuration of a digital camera 100 according to a first exemplary embodiment, and FIGS. 1B and 1C are diagrams illustrating an example of appearance of the digital camera 100.

FIG. 2 is a block diagram illustrating a configuration of a mobile phone 200 according to the first exemplary embodiment.

FIG. 3 is a block diagram illustrating a software configuration of the mobile phone 200 according to the first exemplary embodiment.

FIG. 4 is a diagram illustrating a use case according to the first exemplary embodiment.

FIG. 5 is a flowchart of the mobile phone 200 according to the first exemplary embodiment.

FIG. 6 is a conceptual diagram illustrating a near field communication (NFC) Data Exchange Format (NDEF) data structure according to the first exemplary embodiment.

FIG. 7 is a flowchart of the digital camera 100 according to the first exemplary embodiment.

FIG. 8 is a flowchart of the mobile phone 200 in a case of a re-touch according to the first exemplary embodiment.

### DESCRIPTION OF THE EMBODIMENTS

Exemplary embodiments will be described in detail below with reference to the accompanying drawings.

The exemplary embodiments described below are not seen to be limiting, and changes and modifications may be made as appropriate according to a configuration of an apparatus to which the exemplary embodiments are applied as well as various conditions. The exemplary embodiments may be combined as appropriate.

### Configuration of Digital Camera

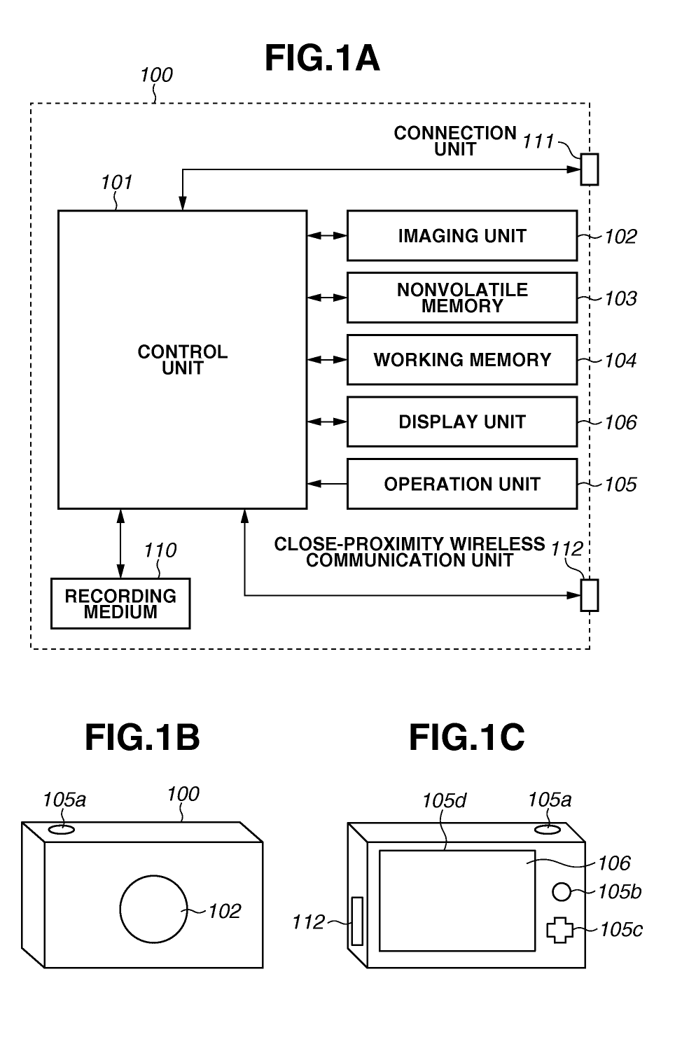

FIG. 1A is a block diagram illustrating a configuration example of a digital camera 100, which is an example of a communication apparatus according to a first exemplary embodiment. While the digital camera 100 is described here as an example of the communication apparatus, the communication apparatus is not limited thereto. For example, the communication apparatus may be a portable media player or an information processing apparatus such as a tablet device and a personal computer.

A control unit 101 controls various units in the digital camera 100 according to input signals and a program to be described below. Instead of the control unit 101 controlling the entire apparatus, a plurality of pieces of hardware may perform processing in a shared manner to control the entire apparatus.

An imaging unit 102 includes, for example, an optical lens unit, an optical system for controlling an aperture, zooming, and focusing, and an image sensor for converting light (video image) introduced through the optical lens unit into an electrical video image signal. A complementary metal oxide semiconductor (CMOS) sensor or charge coupled device (CCD) sensor is usually used as the image sensor. The imaging unit 102 is controlled by the control unit 101 to convert object light focused by a lens included in the imaging unit 102 into an electrical signal via the image sensor, perform noise reduction processing, and output digital data as image data. The digital camera 100 according to the present exemplary embodiment records the image data on a recording medium 100 according to the Design rule for Camera File system (DCF) standard.

A nonvolatile memory 103 is an electrically erasable and recordable nonvolatile memory. The nonvolatile memory 103 stores the program to be described below, which is executed by the control unit 101.

A working memory 104 is used as a buffer memory for temporarily storing the image data captured by the imaging unit 102, an image display memory for a display unit 106, and a work area of the control unit 101.

An operation unit 105 is used to accept instructions to the digital camera 100 from the user. For example, the operation unit 105 includes a power button for the user instructing the digital camera 100 to power on/off, a release switch for instructing the digital camera 100 to capture an image, and a playback button for instructing the digital camera 100 to reproduce image data. The operation unit 105 further includes an operation member such as a dedicated connection button for starting communication with an external apparatus via a connection unit 111 to be described below. A touch panel formed on a display unit 106 to be described below is also included in the operation unit 105. The release switch includes switch 1 (SW1) and switch 2 (SW2). If the release switch enters a half-pressed state, SW1 turns on. The operation unit 105 thereby accepts instructions for imaging preparations. Examples of the imaging preparations include automatic focusing (AF) processing, automatic exposure (AE) processing, automatic white balance (AWB) processing, and flash preliminary light emission (electronic flash (EF)) processing. If the release switch enters a full-pressed state, SW2 turns on. The operation unit 105 thereby accepts an instruction to perform imaging.

The display unit 106 displays a viewfinder image during imaging, captured image data, and characters for interactive operations. The display unit 106 does not necessarily need to be built in the digital camera 100. The digital camera 100 only needs to be connectable to an internal or external display unit 106 and to include at least a display control function for controlling a display of the display unit 106.

The recording medium 110 can record the image data output from the imaging unit 102. The recording medium 110 may be configured to be attachable to and detachable from the digital camera 100 or built in the digital camera 100. In other words, the digital camera 100 only needs to include at least a unit for accessing the recording medium 110.

The connection unit 111 is an interface for connecting to an external apparatus. The digital camera 100 according to the present exemplary embodiment can exchange data with the external apparatus via the connection unit 111. For example, the image data generated by the imaging unit 102 can be transmitted to the external apparatus via the connection unit 111. In the present exemplary embodiment, the connection unit 111 includes an interface for communicating with the external apparatus by using a wireless LAN compliant with the Institute of Electrical and Electronics Engineers (IEEE) 802.11 standard. The control unit 101 controls the connection unit 111 to achieve wireless communication with the external apparatus. The communication method is not limited to a wireless LAN. For example, an infrared communication method may be included. The connection unit 111 is an example of a first wireless communication unit.

The connection unit 111 of the digital camera 100 according to the present exemplary embodiment has an access point (AP) mode in which the digital camera 100 operates as an access point in an infrastructure mode, and a client (CL) mode in which the digital camera 100 operates as a client in the infrastructure mode. With the connection unit 111 operating in the CL mode, the digital camera 100 according to the present exemplary embodiment can operate as a CL apparatus in the infrastructure mode. If the digital camera 100 operates as a CL apparatus, the digital camera 100 can connect to an AP apparatus nearby to join a network formed by the AP apparatus.

With the connection unit 111 operating in the AP mode, the digital camera 100 according to the present exemplary embodiment can operate as a simplified AP (hereinafter, simple AP), which is a kind of AP with limited functions. If the digital camera 100 operates as a simple AP, the digital camera 100 starts to regularly issue a beacon by itself to form a network. Apparatuses near the digital camera 100 can identify the digital camera 100 as an AP apparatus and join the network formed by the digital camera 100.

The AP mode and the CL mode can be switched by making a determination based on information that is written by a mobile phone 200 by using close-proximity wireless communication via a close-proximity wireless communication unit 112.

For example, the close-proximity wireless communication unit 112 includes an antenna unit for wireless communication and a modulation and demodulation circuit for processing a wireless signal. The close-proximity wireless communication unit 112 outputs a modulated wireless signal from an antenna and demodulates a wireless signal received by the antenna to implement noncontact close-proximity wireless communication. For example, the close-proximity wireless communication unit 112 implements noncontact close-proximity wireless communication compliant with the International Organization for Standardization (ISO)/International Electrotechnical Commission (IEC) 18092 standard (near field communication (NFC)). With the communication established, if the close-proximity wireless communication unit 112 receives a data read request from another device, the close-proximity wireless communication unit 112 outputs data stored in a nonvolatile memory (not illustrated) in the close-proximity wireless communication unit 112. The nonvolatile memory (not illustrated) in the close-proximity wireless communication unit 112 is accessible not only from other devices but also from the control unit 101.

In the following description, the close-proximity wireless communication unit 112 may also be referred to as an NFC tag. The data stored in the nonvolatile memory will be described as being compliant with the NFC Data Exchange Format (NDEF). The nonvolatile memory stores data such as communication parameters (service set identifier (SSID) and password) of the network formed by the digital camera 100 in the simple AP mode and an Internet Protocol (IP) address of the digital camera 100. A configuration of the NDEF according to the present exemplary embodiment will be described below. The data stored in the nonvolatile memory is not limited to the NDEF. For example, binary data compliant with a tag format defined by the NFC Forum may be uniquely defined and stored in the nonvolatile memory. Such information includes default values or randomly-generated values. The information is reset at least when the digital camera 100 is powered on. More specifically, after power-on, the control unit 101 overwrites the contents of the nonvolatile memory with default values or randomly-generated values according to the configuration of the NDEF regardless of the current state of the NDEF.

The digital camera 100 according to the present exemplary embodiment determines a mode in which the digital camera 100 is to operate, i.e., the AP mode or the CL mode, and establishes wireless LAN communication with another device at a timing when the other device performs writing to the nonvolatile memory of the close-proximity wireless communication unit 112. Once the wireless LAN communication with the other device is established, the control unit 101 returns the data in the nonvolatile memory about the close-proximity wireless communication to the state before the writing. In view of security, the password of a communication parameter may be changed each time the state is returned. The timing to return the state of the nonvolatile memory of the close-proximity wireless communication unit 112 is not limited thereto. For example, the state may be rewritten before the formation of the wireless LAN network. The password can be changed at that time to eliminate the possibility for the password of the formed wireless LAN network to leak out through the NFC. This can achieve a higher secure system.

The digital camera 100 starts communication with and is connected to the mobile phone 200 to be described below by putting the close-proximity wireless communication unit 112 and a close-proximity wireless communication unit 212 into close proximity. If the close-proximity wireless communication unit 112 is used to connect to the mobile phone 200, the close-proximity wireless communication units 112 and 212 do not necessarily need to be brought into contact with each other. The close-proximity wireless communication units 112 and 212 can communicate with each other at a certain distance. To connect the two apparatuses, the close-proximity wireless communication units 112 and 212 therefore have only to be put close to each other within a range capable of close-proximity wireless communication. In the following description, putting the close-proximity wireless communication units 112 and 212 close to each other within the range capable of close-proximity wireless communication will be referred to as putting the close-proximity wireless communication units 112 and 212 into close proximity.

If the close-proximity wireless communication units 112 and 212 of the two apparatuses are in a range not capable of close-proximity wireless communication, communication will not be started. If the digital camera 100 and the mobile phone 200 shift from a state of being connected by close-proximity wireless communication to a state where the close-proximity wireless communication units 112 and 212 are separated up to the range not capable of close-proximity wireless communication, the communication is disconnected. The noncontact close-proximity communication to be implemented by the close-proximity wireless communication unit 112 is not limited to NFC. Other wireless communications may be employed. For example, noncontact close-proximity communications complaint with the ISO/IEC 14443 standard may be employed as the noncontact close-proximity communication to be implemented by the close-proximity wireless communication unit 112.

In the present exemplary embodiment, the communication speed of the communication implemented by the connection unit 111 is higher than that of the communication implemented by the close-proximity wireless communication unit 112 to be described below. The communication implemented by the connection unit 111 also has a communication coverage wider than that of the communication by the close-proximity wireless communication unit 112. On the other hand, the communication by the close-proximity wireless communication unit 112 can limit the communication partner due to the narrow communication coverage. The communication by the close-proximity wireless communication unit 112 therefore does not need processing for exchanging encryption keys, which is needed for the communication implemented by the connection unit 111. In other words, the communication by the close-proximity wireless communication unit 112 can be performed more handily than that using the connection unit 111. A program for operating the digital camera 100 described above is stored in the nonvolatile memory 103.

The digital camera 100 according to the present exemplary embodiment is a simple AP which is a kind of AP but does not have a gateway function for transferring data received from a CL apparatus to an Internet provider. The digital camera 100 is therefore not able to transfer data received from another apparatus joining the network formed by itself to a network such as the Internet.

Next, an appearance of the digital camera 100 will be described. FIGS. 1B and 1C are diagrams illustrating an example of the appearance of the digital camera 100. A release switch 105a, a playback button 105b, arrow keys 105c, and a touch panel 105d are operation members included in the operation unit 105 described above. The display unit 106 displays an image obtained as a result of imaging by the imaging unit 102. The digital camera 100 according to the present exemplary embodiment includes an antenna portion of the close-proximity wireless communication unit 112 on a side surface of a camera housing. The digital camera 100 can establish close-proximity wireless communication with another apparatus by putting their close-proximity wireless communication units 112 close to each other within a certain distance. In such a manner, the digital camera 100 can perform noncontact communication without using a cable, and limit the communication partner according to the user's intention.

The digital camera 100 has been described above.

### Configuration of Mobile Phone

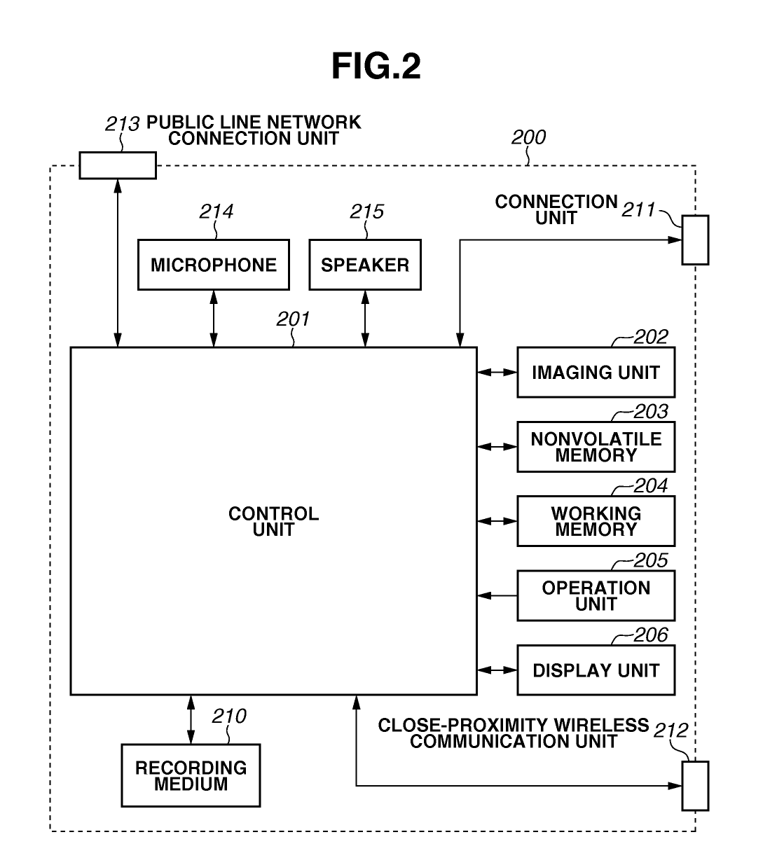

FIG. 2 is a block diagram illustrating a configuration example of the mobile phone 200, which is an example of an information processing apparatus according to the present exemplary embodiment. While the mobile phone 200 is described here as an example of the information processing apparatus, the information processing apparatus is not limited thereto. For example, the information processing apparatus may be a digital camera, a tablet device, or a personal computer having a wireless function.

A control unit 201 controls each part of the mobile phone 200 according to input signals and a program to be described below. Instead of the control unit 201 controlling the entire apparatus, a plurality of pieces of hardware may control the entire apparatus in a shared manner.

An imaging unit 202 converts object light focused by a lens included in the imaging unit 202 into an electrical signal, performs noise reduction processing, and outputs digital data as image data. The captured image data is stored in a buffer memory before the control unit 201 performs a predetermined calculation thereon and records the resulting image data on a recording medium 210.

A nonvolatile memory 203 is an electrically erasable and recordable nonvolatile memory. An operating system (OS), which is basic software executed by the control unit 201, and applications for implementing applicative functions in cooperation with the OS are recorded in the nonvolatile memory 203. In the present exemplary embodiment, an application for communicating with the digital camera 100 is stored in the nonvolatile memory 203.

A working memory 204 is used as an image display memory of a display unit 206 and a work area of the control unit 201.

An operation unit 205 is used to accept instructions to the mobile phone 200 from the user. The operation unit 205 includes operation members such as a power button by which the user can instruct the mobile phone 200 to power on/off and a touch panel formed on the display unit 206.

The display unit 206 displays image data and characters for interactive operations. In addition, the mobile phone 200 does not necessarily need to include the display unit 206. The mobile phone 200 only has to be connectable to the display unit 206 and include at least a display control function for controlling a display of the display unit 206.

The recording medium 210 can record the image data output from the imaging unit 202. The recording medium 210 may be configured to be attachable to and detachable from the mobile phone 200 or built in the mobile phone 200. In other words, the mobile phone 200 has only to include at least a unit for accessing the recording medium 210.

A connection unit 211 is an interface for connecting to an external apparatus. The mobile phone 200 according to the present exemplary embodiment can exchange data with the digital camera 100 via the connection unit 211. In the present exemplary embodiment, the connection unit 211 is an antenna. The control unit 201 can be connected to the digital camera 100 via the antenna. The connection with the digital camera 100 may be established by direct connection or via an access point. For example, Picture Transfer Protocol over Internet Protocol (PTP/IP) via a wireless LAN can be used as a protocol for data communication. The communication with the digital camera 100 is not limited thereto. For example, the connection unit 211 may include wireless communication modules such as an infrared communication module, a Bluetooth (registered trademark) communication module, and a Wireless Universal Serial Bus (USB).

The close-proximity wireless communication unit 212 is a communication unit for implementing noncontact close-proximity wireless communication with another device. The close-proximity wireless communication unit 212 includes an antenna used for wireless communication, and a modulation and demodulation circuit and a communication controller for processing a wireless signal. The close-proximity wireless communication unit 212 outputs a modulated wireless signal from the antenna and demodulates a wireless signal received by the antenna to implement noncontact close-proximity communication. For example, the close-proximity wireless communication unit 212 implements noncontact close-proximity communication compliant with the ISO/IEC 18092 standard (NFC). In the present exemplary embodiment, the close-proximity wireless communication unit 212 can operate in a card reader mode, a card writer mode, and a peer to peer (P2P) mode, which are defined by the NFC standard. The close-proximity wireless communication unit 212 behaves mainly as an initiator.

A public line network connection unit 213 is an interface used when public line wireless communication is performed. The mobile phone 200 can make a telephone call to another apparatus via the public line network connection unit 213. At that time, the control unit 201 inputs and outputs voice signals via a microphone 214 and a speaker 215 to carry out telephone call. In the present exemplary embodiment, the public line network connection unit 213 is an antenna. The control unit 201 can connect to the public line network via the antenna. One antenna may be used for both the connection unit 211 and the public line network connection unit 213.

The mobile phone 200 has been described above.

In the present exemplary embodiment, the description will be made assuming that the close-proximity wireless communication unit 112 of the digital camera 100 behaves as a target, and that the close-proximity wireless communication unit 212 of the mobile phone 200 as an initiator. More specifically, the close-proximity wireless communication unit 212 of the mobile phone 200 issues a carrier, and the close-proximity wireless communication unit 112 of the digital camera 100 is driven by the resulting power. The close-proximity wireless communication unit 112 of the digital camera 100 can be driven by the carrier from the close-proximity wireless communication unit 212 of the mobile phone 200 without power supply from the main body of the digital camera 100. If the power supply of the digital camera 100 is on, the close-proximity wireless communication unit 112 can operate on the power supplied from the power supply of the digital camera 100. The target-initiator relationship between the apparatuses may be reversed. The mobile phone 200 may function as an access point instead of the digital camera 100. Alternatively, suppose that there is a network formed by an access point separate from both the digital camera 100 and the mobile phone 200, and either one of the apparatuses is participating in the network. In such a case, if the other apparatus comes into close proximity, the communication parameters of the participating network may be shared between the apparatuses.

### Software Configuration of Mobile Phone

Next, a software configuration diagram of the mobile phone 200 according to the first exemplary embodiment will be described.

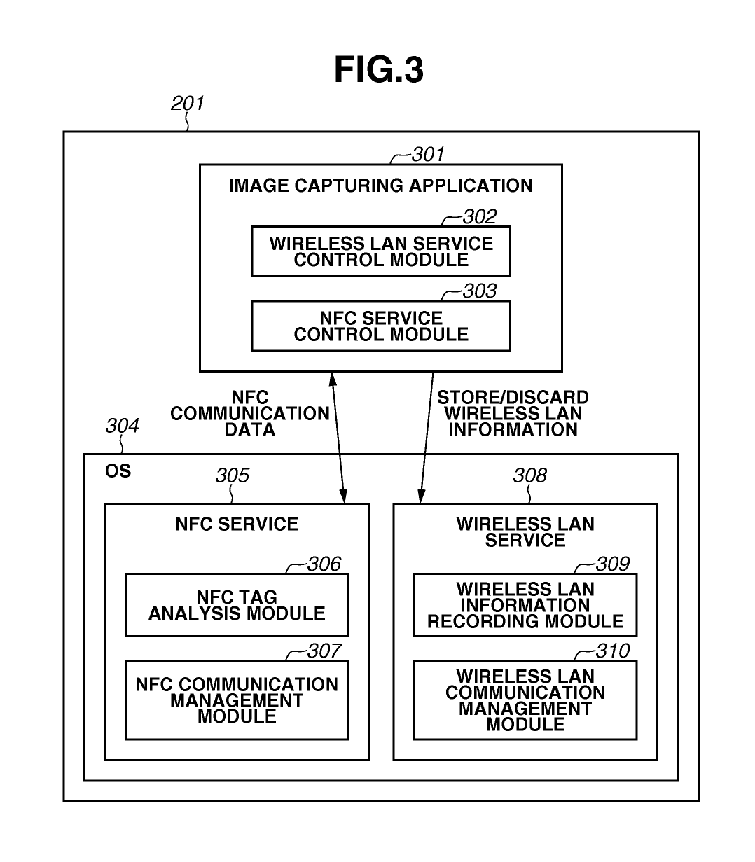

FIG. 3 is a software configuration diagram of the mobile phone 200. Various types of fixed data and firmware are recorded in the nonvolatile memory 203 of the mobile phone 200.

An OS 304, which is basic software executed by the control unit 201, and an application, which is application software executed by the control unit 201 are recorded on the recording medium 210. An image capturing application 301 (hereinafter, also referred to as an application 301) for connecting to the digital camera 100 and capturing an image is recorded as the application software.

If the user turns on a power switch included in the operation unit 205 of the mobile phone 200, power is supplied to each unit of the mobile phone 200. The control unit 201 reads the OS 304 from the recording medium 201, loads the OS 304 into the working memory 204, and executes the OS 304. The control unit 201 controls each unit of the mobile phone 200 according to the OS 304 and the application 301 installed on the OS 304. In the following description of FIG. 3, that the control unit 201 executes predetermined processing according to the application 301 (or a function of the application 301, the OS 304, or a service of the OS 304) will be expressed like “the application 301 (or a function of the application 301, the OS 304, or a service of the OS 304) performs predetermined processing”.

The OS 304 not only includes the function of controlling each unit of the mobile phone 200, but also provides various services for the application 301. As characteristic functions of the present exemplary embodiment, the OS 304 includes an NFC service 305 and a wireless LAN service 308.

The NFC service 305 controls NFC communication using the close-proximity wireless communication unit 212 via an NFC communication management module 307. More specifically, the NFC service 305 receives data via NFC communication using the close-proximity wireless communication unit 212, and transmits data in response to a request from the image capturing application 301. The data received at that time is provided to the image capturing application 301.

An NFC tag analysis module 306 determines and analyzes a structure of the received data, and changes the structure into a data structure appropriate for the application 301. In such a manner, the NFC service 305 can transform the data into a form interpretable by the application 301 and provide the data to the application 301, and vice versa.

Data to be exchanged by NFC communication is usually compliant with the NDEF format. The NFC tag analysis module 306 thus has a function of determining whether the received data is in a format compliant with the NDEF.

The wireless LAN service 308 performs the following functions by using a wireless LAN communication management module 310. Specifically, the wireless LAN service 308 controls data communication via a wireless LAN, such as on/off of a wireless LAN function, searching (scanning) for surrounding networks, joining a network. The wireless LAN service 308 also provides data obtained by communication using the wireless LAN to the application 301, and controls transmission and reception of data via the wireless LAN in response to requests from the application 301. The wireless LAN service 308 further performs processing for managing storage and discard of communication parameters for wireless LAN communication by using a wireless LAN information recording module 309. The storage and discard of the communication parameters are also controlled in response to the requests from the application 301.

The image capturing application 301 includes the following two functions. One is a function of connecting to the digital camera 100 via a wireless LAN by using the communication parameters of the wireless LAN received by close-proximity wireless communication. The other one is a function of receiving image data from the recording medium 110 of the digital camera 100 and storing the image data into the recording medium 210. The image capturing application 301 implements services in cooperation with the OS 304 by using the following modules.

A wireless LAN service control module 302 performs processing for storing communication parameters for wireless LAN communication, and processing for instructing the OS 304 to control on/off the wireless LAN.

An NFC service control module 303 performs processing for receiving NFC communication data, analyzing the received data, and extracting communication parameters for wireless LAN communication. The NFC service control module 303 also performs processing for instructing the OS 304 to transmit NFC communication data for proceeding with connection processing to the digital camera 100.

### Description of Use Case

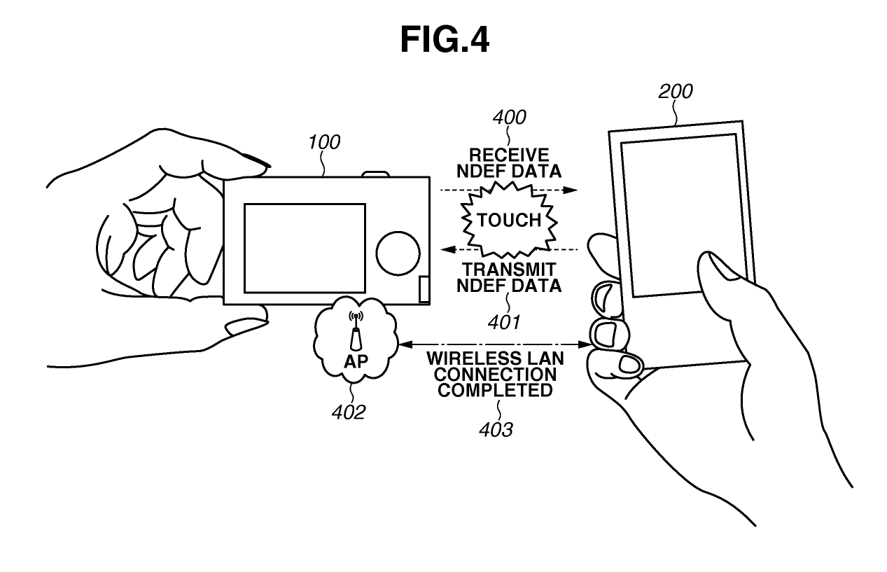

Next, a use case according to the first exemplary embodiment will be described. FIG. 4 is a diagram illustrating a procedure for establishing wireless LAN communication between the digital camera 100 and the mobile phone 200 using close-proximity wireless communication. Hereinafter, a series of processes for establishing wireless LAN communication using close-proximity wireless communication will be referred to as a wireless LAN handover.

As illustrated in FIG. 4, to start a wireless LAN handover, the user puts the close-proximity wireless communication unit 112 of the digital camera 100 and the close-proximity wireless communication unit 212 of the mobile phone 200 into close proximity to start close-proximity wireless communication.

Next, as illustrated by an arrow 400, the mobile phone 200 receives NDEF data from the close-proximity wireless communication unit 112 of the digital camera 100 via the close-proximity wireless communication unit 212. The NDEF data includes communication parameters needed for wireless LAN connection.

Next, as illustrated by an arrow 401, the mobile phone 200 transmits NDEF data to the digital camera 100 via the close-proximity wireless communication unit 212 as a response to the reception of the arrow 400. The NDEF data includes information indicating the completion of reading of the foregoing NDEF data. The digital camera 100 and the mobile phone 200 exchange their respective identification values (universally unique identifiers (UUIDs)) for unique identification. As a result, the digital camera 100 and the mobile phone 200 can mutually determine whether the partner is the device to connect thereto, before wireless LAN communication is established.

Finally, the digital camera 100 determines whether to enter the AP mode or the CL mode based on the NDEF data transmitted as a response from the mobile phone 200. If the digital camera 100 enters the AP mode, as illustrated by arrows 402 and 403, the digital camera 100 starts up an AP and starts to issue a beacon including some of the communication parameters transmitted to the mobile phone 200 as illustrated by the arrow 400. The digital camera 100 receives a request from the mobile phone 200 that has received the beacon, and completes the wireless LAN connection.

For example, if the OS 304 is “Android”, the writing of the NDEF data to the NFC tag can be easily implemented by using an application programming interface (API) provided by Android. To write NDEF data into an NFC tag, for example, what size of data is written into what area needs to be specified. After the writing, attribute information about the area needs to be updated. By using the API, the application 301 has only to specify the data to write. In other words, the application 301 has only to take into account the handling of the payload section of the data. However, if the API is used, it is difficult to rewrite only predetermined items while keeping the items other than the predetermined items intact. Suppose that the application 301 instructs the OS 304 to write information indicating the completion of reading. In such a case, information indicating that nothing is recorded in areas where the other information was recorded (areas where the SSID and the password were written) is written into the NDEF header. In other words, the other information is handled as if deleted. This produces the following problem. When the digital camera 100 forms a network, the digital camera 100 uses the communication parameters recorded in the NFC tag. The digital camera 100 thereby shares the communication parameters with the mobile phone 200. However, if the mobile phone 200 writes the completion of reading the information of the NFC tag and the communication parameters are thereby deleted, the digital camera 100 is not able to obtain the communication parameters for use in generating a network. For this reason, the mobile phone 200 writes back the information of the NFC tag just read, in addition to the completion of reading the information of the NFC tag. As a result, at least the items in which the communication parameters are recorded are restored to the same state as those before the reading of the NFC tag, so that the digital camera 100 can obtain the communication parameters of the network to form.

The flow of a wireless LAN handover using close-proximity wireless communication has been described above. In such a manner, the user can easily establish wireless LAN connection by simply putting the apparatuses into close proximity without the need to perform an operation for inputting the communication parameters of the wireless LAN.

Compared to wireless communications such as a wireless LAN and Bluetooth (registered trademark), close-proximity wireless communication needs a certain level of accuracy in terms of a positional relationship between the devices to be put in close proximity for communication and the duration of the state in close proximity. Close-proximity wireless connection can thus be disconnected in the process of communication due to the user's action.

In the use case where a wireless LAN handover is performed as described above, the close-proximity wireless communication may be disconnected in the middle of the processing for receiving the NDEF data (400). The close-proximity wireless communication may be disconnected in the middle of the processing for transmitting the NDEF data (401).

In the former case, the user can retry the wireless LAN handover by putting the apparatuses in close proximity again. In the latter case, the transmission processing (401) is discontinued halfway and the transmission of the NDEF data may be left unfinished. This can produce the following problem. For example, suppose that the initiator transmits NDEF data to the target according to the NFC type-3 tag communication standard. For exclusive access control, a “write flag” is set on a specific area of the NDEF header in the nonvolatile memory of the target. The write flag is updated upon completion of writing of the NDEF data, and the exclusive access control is controlled to be ended by the update. If the writing fails to be completed, i.e., if the writing of the NDEF data is discontinued in the middle of the transmission, the write flag can be left set on. If the write flag remains on, the OS 304 of the mobile phone 200 is not able to obtain the NDEF data due to the exclusive access control. Even if the control unit 101 of the digital camera 100 attempts to access thereto, the control unit 101 recognizes the NDEF data to be exclusively controlled and is not able to extract information. This can cause a problem that a wireless LAN handover cannot be started no matter how many times the user puts the apparatuses into close proximity again. To escape from such a state, the digital camera 100 needs to be once powered off and on again to refresh the contents of the memory of the close-proximity wireless communication unit 112.

In close-proximity wireless communication, data to be read or written is divided into predetermined data sizes to perform communication in a plurality of communications. Possible settings of the dividing data size are determined by the tag formats defined by the NFC Forum. The greater the dividing data size, the longer it takes to perform a single communication and the more likely the foregoing problem is to occur.

As described above, the stability of the NFC communication path is affected by the user's action. As a result, there has been a possibility that the data exchange by the NFC communication fails and the handover to wireless LAN communication does not proceed smoothly. In the present exemplary embodiment, the contents of the NFC tag are then recorded in such order that information essential to connection (information of higher priority) is exchanged first. This saves the user's work in carrying out a handover to wireless LAN communication if reading or writing fails. Hereinafter, operations of the apparatuses for such an implementation will be described.

### Operation of Mobile Phone

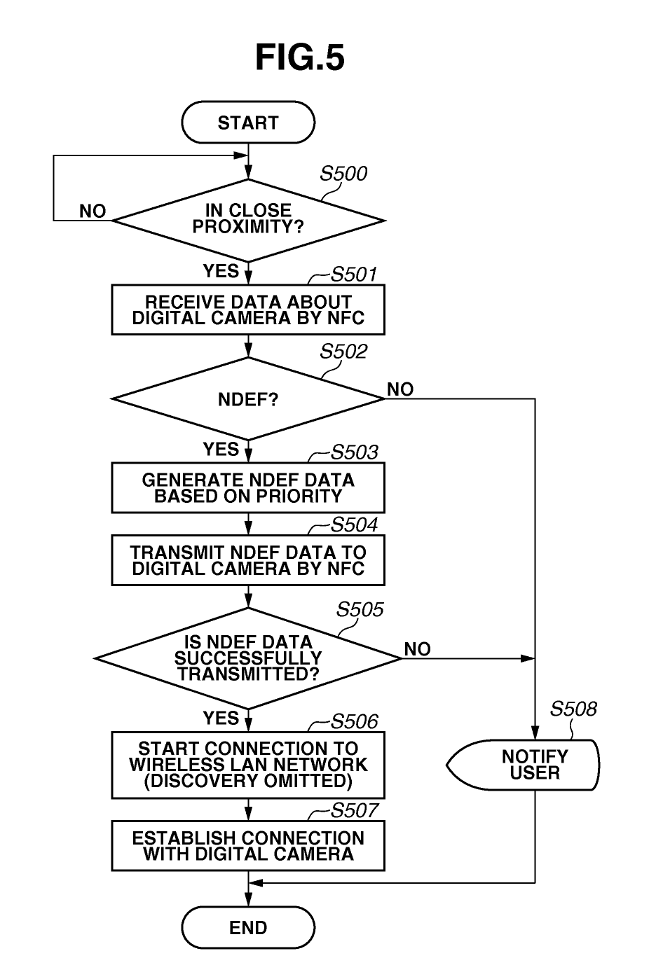

FIG. 5 illustrates a flowchart of a wireless LAN handover to the digital camera 100 by the mobile phone 200 according to the present exemplary embodiment. The processing of this flowchart is implemented by the control unit 201 of the mobile phone 200 reading the OS 304 and the image capturing application 301 from the nonvolatile memory 203, loading the OS 304 and the image capturing application 301 into the working memory 204, and executing the OS 304 and the image capturing application 301. For ease of description, the flowchart is described below without a distinction between control of the OS 304 and that of the image capturing application 301. The processing of this flowchart is started in response to the power on of the mobile phone 200 and completion of the activation of the OS 304.

In step S500, the control unit 201 determines whether the close-proximity wireless communication unit 212 is in close proximity to the digital camera 100. If the close-proximity wireless communication unit 212 is determined to be in close proximity to the digital camera 100 (YES in step S500), the processing proceeds to step S501.

In step S501, the control unit 201 receives data about the digital camera 100 from the close-proximity wireless communication unit 112 of the digital camera 100 in close proximity by using the close-proximity wireless communication unit 212. The received data includes information about a wireless LAN network to be constructed by the simple AP function of the digital camera 100, an IP address of the digital camera 100, and identification information about the digital camera 100.

In the present exemplary embodiment, the UUID of the digital camera 100 is used as the identification information. Network information for connecting to another apparatus, user input information for identifying the digital camera 100, and/or unique information about an NFC chip mounted on the digital camera 100 may be used.

In step S502, the OS 304 executed by the control unit 201 performs NFC tag analysis on the received data received in step S501. In the NFC tag analysis, the OS 304 refers to a header area of the received data and determines whether the received data is in a format compliant with NDEF. If the received data is determined to be in NDEF (YES in step S502), the OS 304 passes an intent including a character string “NDEF DISCOVERED” and data on the character string to the application 301. The application 301 finds out the determination result of the OS 304 based on the intent. If the OS 304 determines that the received data is in NDEF (YES in step S502), the processing proceeds to step S503. On the other hand, if the OS 304 determines that the received data is not in NDEF (NO in step S502), the control unit 201 determines that the close-proximity wireless communication failed, and the processing proceeds to step S508.

The case where the processing proceeds to step S503 will be described first.

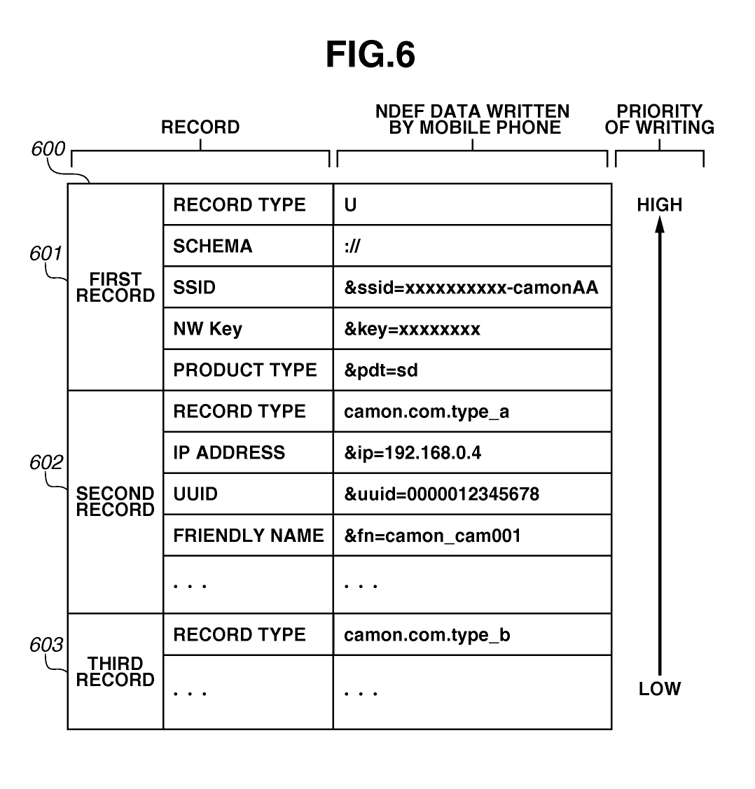

In step S503, the control unit 201 generates NDEF data to be transmitted to the digital camera 100 via the close-proximity wireless communication unit 112. FIG. 6 illustrates a conceptual diagram of the generated NDEF data. In FIG. 6, NDEF data 600 includes three records. A first record 601 stores minimum required data for communication with the digital camera 100. The first record 601 stores the information about the wireless LAN network to be constructed by the simple AP function of the digital camera 100, received in step S501. A second record 602 stores the IP address of the digital camera 100, the UUID of the mobile phone 200, and a friendly name. A third record 603 stores other information. According to the NDEF standard, records of higher order are written first. The higher the order of a record, the higher the priority of the data.

The description returns to FIG. 5.

In step S504, the control unit 201 transmits the NDEF data generated in step S503 to the close-proximity wireless communication unit 112 of the digital camera 100 via the close-proximity wireless communication unit 212.

In step S505, the control unit 201 determines whether the NDEF data is successfully transmitted in step S504. More specifically, if the writing of the NDEF data is completed, the close-proximity wireless communication unit 112 of the digital camera 100 returns a response to the writing. If the response is received, the control unit 201 determines that the writing of the NDEF data from the mobile phone 200 is normally completed (i.e., the NDEF data is successfully written). In step S505, if the NDEF data is determined to be successfully written (YES in step S505), the processing proceeds to step S506. In step S505, if the writing of the NDEF data is determined to have failed (NO in step S505), the processing proceeds to step S508.

In step S506, the control unit 201 starts processing for connecting to the wireless LAN network of the digital camera 100 by using the connection unit 211 based on the information (network information) received in step S501. In the present exemplary embodiment, the control unit 201 attempts to perform connection by using the IP address of the digital camera 100 read in step S501. This can omit a procedure for finding out what devices are included in the network (discovery), and enable faster connection to the digital camera 100.

In step S507, the mobile phone 200 establishes connection (communication) with the digital camera 100.

The case where the processing proceeds to step S508 will be described. In step S508, the control unit 201 notifies the user of the failure of the close-proximity wireless communication. For example, the control unit 201 displays a message “NFC communication failed. Touch again” on the display unit 206 to inform the user of the failure of the NFC communication, and prompts the user to retry a handover.

The flowchart of the wireless LAN handover to the digital camera 100 by the mobile phone 200 according to the present exemplary embodiment has been described above.

### Operation of Digital Camera

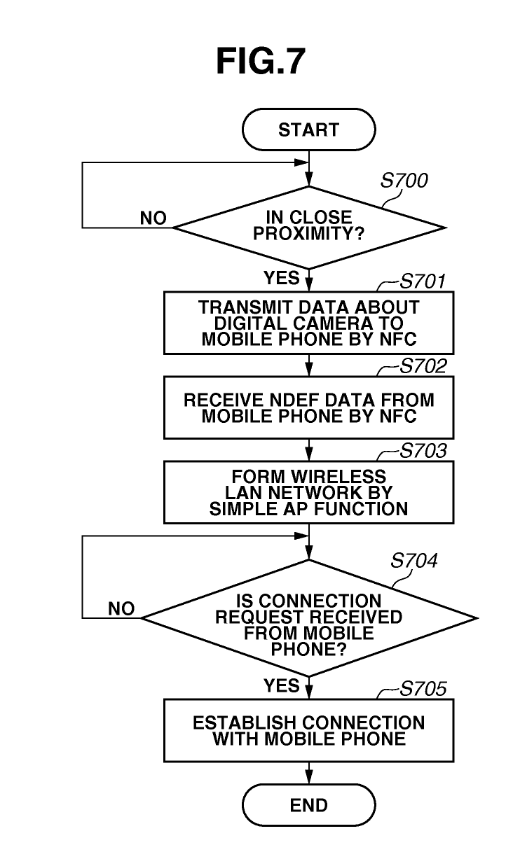

FIG. 7 illustrates a flowchart of a wireless LAN handover to the mobile phone 200 by the digital camera 100 according to the present exemplary embodiment.

In step S700, the close-proximity wireless communication unit 112 determines whether the close-proximity wireless communication unit 212 of the mobile phone 200 is in close proximity therewith. More specifically, the close-proximity wireless communication unit 112 detects a change in induced electromotive force occurring from a change in a magnetic field caused by the close-proximity wireless communication unit 212 of the mobile phone 200 and thereby determines whether the close-proximity wireless communication unit 212 is in close proximity. If the close-proximity wireless communication unit 112 determines that the close-proximity wireless communication unit 212 is in close proximity therewith (YES in step S700), the processing proceeds to step S701.

In step S701, the close-proximity wireless communication unit 112 transmits the identification information about the digital camera 100 and the information about the wireless LAN network to be constructed by the simple AP function of the digital camera 100, to the mobile phone 200. At this time, the data is transmitted in order from the records of higher order of the NDEF. For that purpose, the control unit 101 of the digital camera 100 previously performs control to record the data of higher priority into the records of higher order. More specifically, the control unit 101 stores the information about the wireless LAN network to be constructed by the simple AP function of the digital camera 100 into a record of higher order. The control unit 101 stores the IP address of the digital camera 100 into a record of lower order. In terms of the SSID and the IP address, similar records to those of data to be written by the mobile phone 200 (for example, the data of FIG. 6) are read in descending order. This can increase the possibility of successfully reading at least the information about the wireless LAN network, for example, even if the user separates the apparatuses from each other in the middle of step S701 and the communication is disconnected and the reading of the data is discontinued.

In step S702, the close-proximity wireless communication unit 112 receives the data generated by the mobile phone 200 (the NDEF data generated in step S503, recorded in descending order of priority). In response, the digital camera 100 starts to supply power to each unit.

In step S703, the control unit 101 forms a wireless LAN network by the simple AP function of the own apparatus. At that time, the control unit 101 forms the wireless LAN network by using the communication parameters included in the NDEF data received in step S702.

In step S704, the control unit 101 determines whether a connection request from the mobile phone 200 is received by the connection unit 111. If a connection request is not received (NO in step S704), the control unit 101 waits for a connection request until a predetermined time elapses. If a connection request is received (YES in step S704), the control unit 101 checks whether the source apparatus of the connection request is the mobile phone 200 indicated by the information received in step S702. If the source apparatus of the connection request is confirmed to be the mobile phone 200 indicated by the information received in step S702 (YES in step S704), the processing proceeds to step S705.

In step S705, the control unit 101 establishes connection with the mobile phone 200 via the connection unit 111.

The present exemplary embodiment has been described by using an example where the NDEF data is divided into three records as illustrated in FIG. 6. Note that this is not restrictive. For example, the pieces of data may be arranged in order of priority and stored in one record.

The flowchart of the wireless LAN handover to the mobile phone 200 by the digital camera 100 according to the present exemplary embodiment has been described above.

### Operation of Mobile Phone in a Case of Re-Touch

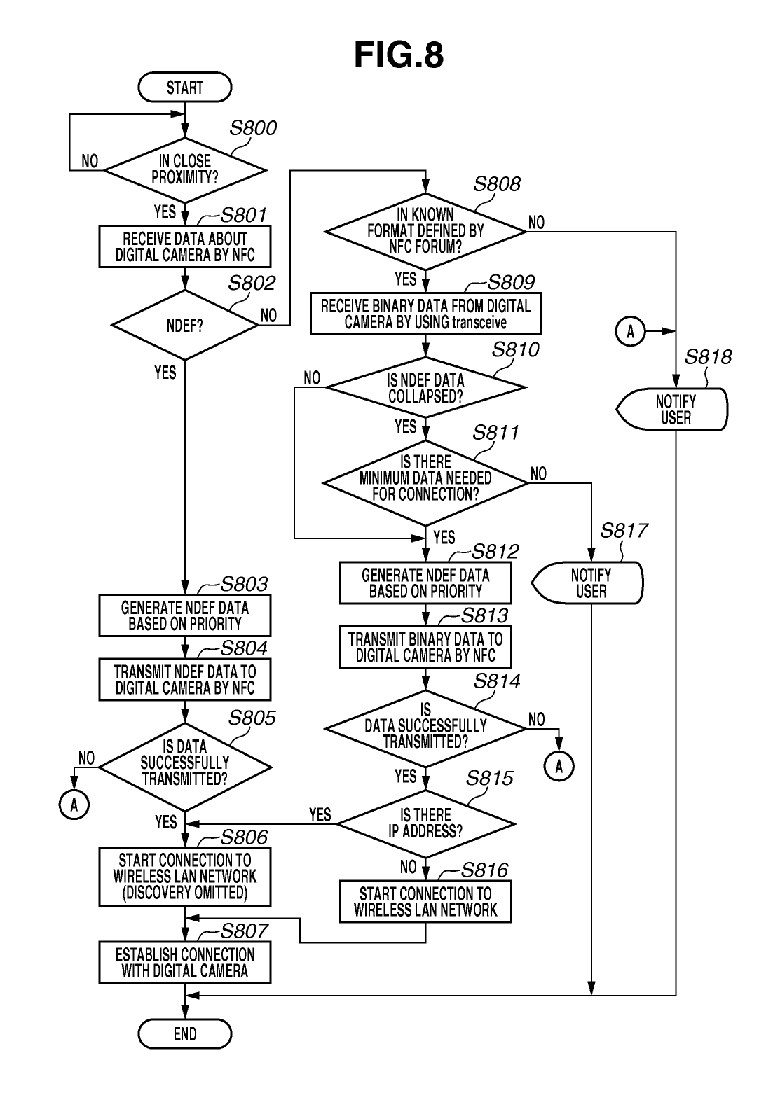

FIG. 8 illustrates a flowchart for a case where a wireless LAN handover attempted between the digital camera 100 and the mobile phone 200 as illustrated in FIG. 5 has failed and the wireless LAN handover is attempted again.

In steps S800 to S802, the mobile phone 200 performs similar processing to that of steps S500 to S502 in FIG. 5.

In step S802, if the OS 304 determines that the received data is data in the format compliant with the NDEF (YES in step S802), the processing proceeds to step S803. If the OS 304 determines that the received data is not data in the format compliant with the NDEF (NO in step S802), the processing proceeds to step S808.

In steps S803 to S807, the mobile phone 200 performs similar processing to that of steps S503 to S507 in FIG. 5.

In step S808, the OS 304 determines whether the data determined not to be in NDEF is data in a format compliant with a known format defined by the NFC Forum. If the data is determined not to be in NDEF but in a known format defined by the NFC Forum, the OS 304 passes an intent including a character string “TECH DISCOVERED” and data on the character string to the application 301. The application 301 finds out the determination result of the OS 304 based on the intent.

If the OS 304 determines that the received data is data in a known format defined by the NFC Forum (YES in step S808), the processing proceeds to step S809. If the received data is determined not to be data in a known format defined by the NFC forum (NO in step S808), the processing proceeds to step S818.

The case where the processing proceeds to step S809 will be described first.

In step S809, the control unit 201 receives the data of the close-proximity wireless communication unit 112 of the digital camera 100 in the form of binary data. In other words, the control unit 201 simply obtains the entire data without identifying what information the information about the NDEF header area is. For example, if the OS 304 is Android, a function called transceive, which is one of the standard APIs of Android, may be used. To capture needed data from the binary data, the application 301 itself needs to perform processing that usually can be done by referring to the header. More specifically, the application 301 needs to calculate which area of the data an area where the needed data is recorded is. The application 301, however, can capture even information that the API automatically excludes from reading.

In step S810, the control unit 201 determines whether the NDEF data is collapsed, based on the binary data read in step S809. More specifically, as described above, the control unit 201 checks whether the write flag is set on a specific area of the NDEF header for determination. If the control unit 201 determines that the NDEF data is not collapsed (NO in step S810), the processing proceeds to step S812. If the control unit 201 determines that the NDEF data is collapsed (YES in step S810), the processing proceeds to step S811.

In step S811, the control unit 201 determines whether there is minimum data needed for connection. More specifically, the control unit 201 determines whether the binary data read in step S809 includes the communication parameters (SSID and password) of the wireless LAN to be constructed by the simple AP function of the digital camera 100. As described above, in steps S503 and S504 of FIG. 5, the control unit 201 writes back the data in descending order of priority. The binary data read in step S809 is therefore likely to include data of high priority. If the control unit 201 determines that there are the communication parameters of the wireless LAN (YES in step S811), the processing proceeds to step S812.

In step S812, the control unit 201 performs similar processing to that of step S803 and that of step S503 in FIG. 5.

In step S813, the control unit 201 transmits the NDEF data to the close-proximity wireless communication unit 112 of the digital camera 100 via the close-proximity wireless communication unit 212. At that time, the write flag for exclusive access control is set on the NDEF header of the data read from the digital camera 100 in step S802. In other words, the write flag for exclusive access control is set on the data recorded in the memory of the close-proximity wireless communication unit 122 of the digital camera 100. If the control unit 201 attempts to handle the data as NDEF data like in step S504 of FIG. 5 and step S804 of FIG. 8, the control unit 201 will not be able to write because of the state of the exclusive access control. In step S813, the control unit 201 then handles the data not as NDEF data but as binary data like in step S808. The application 301 instructs the OS 304 to write the binary data into an appropriate area by using the function transceive. The contents of the binary data are in the format of NDEF data as described in FIG. 6. As a result, the NDEF data without the write flag for exclusive access control being set is written to the memory of the close-proximity wireless control unit 112 of the digital camera 100. In other words, the NDEF data can be returned to an accessible state.

In step S814, the control unit 201 determines whether the data is successfully transmitted. More specifically, like in step S505 of FIG. 5 and step S805 of FIG. 8, the control unit 201 determines that the data is successfully transmitted, based on the reception of a response from the digital camera 100 to the transmission of the data. If the control unit 201 determines that the data is successfully transmitted (YES in step S814), the processing proceeds to step S815. If the control unit 201 determines that the transmission of the data has failed (NO in step S811), the processing proceeds to step S818. The processing of step S818 will be described below.

In step S815, the control unit 201 determines whether there is an IP address in the binary data read in step S808. If the control unit 201 determines that there is an IP address (YES in step S815), the processing proceeds to step S806 since the control unit 201, as described above, can attempt to connect by using the IP address for faster connection to the digital camera 100. On the other hand, if the control unit 201 determines that there is no IP address in the binary data (NO in step S815), the processing proceeds to step S816.

In step S816, the control unit 201 attempts to connect to the digital camera 100 without omitting discovery, by using the information read in step S801 about the wireless LAN network constructed by the simple AP function of the digital camera 100. The processing then proceeds to step S807.

On the other hand, in step S811, if the control unit 201 determines that the binary data does not include the information about the wireless LAN network constructed by the simple AP function of the digital camera 100 (NO in step S811), the processing proceeds to step S817. Such a situation occurs if the NFC communication fails at a timing when the information for joining the wireless LAN network formed by the digital camera 100 is written. In step S817, the control unit 201 therefore notifies and prompts the user to power the digital camera 100 off and on again, and put the digital camera 100 and the mobile phone 200 into close proximity again. For example, the control unit 201 displays a message “Connection failed. Restart the digital camera and touch again” on the display unit 206.

Possible situations where the OS 304 determines in step S808 that the data is not in a format compliant with a known format defined by the NFC Forum include the following. The apparatuses may be separated from each other during data reception. The positions to be in close proximity may deviate from each other. As a result, the communication path is discontinued and the data can only be read halfway. In such cases, the processing proceeds to step S818.

In step S818, the control unit 201 notifies the user of the failure of the close-proximity wireless communication, and prompts the user to retry the wireless LAN handover. Unlike the notification in step S817, the control unit 201 at this time displays a message such as “Connection failed. Touch the digital camera again” on the display unit 206. In this case, the digital camera 100 does not need to be powered off and on. The reason is that the failure is likely to result from a simple read error. However, the contents of the NFC tag are also rewritable by a third-party application. Therefore, data of an unidentifiable format therefore may possibly have been written into the NFC tag of the digital camera 100. For this reason, in step S818, the control unit 201 may prompt the user to power off and on the digital camera 100 to refresh the NFC tag like step S817.

The flowchart of the wireless LAN handover to the digital camera 100 by the mobile phone 200 in the case of a re-touch according to the present exemplary embodiment has been described above. In the present exemplary embodiment, for the convenience of description, the first handover has been described with reference to FIG. 5 and a retry of the handover after the failure has been described with reference to FIG. 8. However, the processing for the first time and the processing for the second time do not need to be distinguished, and it is sufficient that the processing of FIG. 8 may be performed all the time.

As described above, in the present exemplary embodiment, when the mobile phone 200 writes back the NDEF data read from the digital camera 100, the mobile phone 200 writes back the NDEF data in order of priority. This can increase the possibility of a successful handover by a re-touch even if the write-back fails. Even if the write-back fails and the NDEF data is left under exclusive access control, the NDEF data can be handled as binary data to perform a handover by a re-touch.

### Other Exemplary Embodiments

The exemplary embodiments can be achieved by the processing that includes supplying a program for implementing one or more functions of the above-described exemplary embodiment to a system or an apparatus via a network or a recording medium, and reading and executing the program by one or more processors in a computer of the system or apparatus. The exemplary embodiments can also be achieved by a circuit that implements one or more of the functions (e.g., an application specific integrated circuit (ASIC)).

Exemplary embodiments can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood the disclosed exemplary embodiments are not seen to be limiting. The scope of the following claims is to be accorded the broadest interpretation so as to encompass all such modifications and equivalent structures and functions.

This application claims the benefit of Japanese Patent Application No. 2014-146011, filed Jul. 16, 2014, which is hereby incorporated by reference herein in its entirety.

What is claimed is:

1. A communication apparatus comprising:
a sharing unit configured to share a plurality of communication parameters for connecting to an external apparatus via a first communication with the external apparatus via a second communication different from the first communication; and
a connection unit configured to connect to the external apparatus via the first communication using the plurality of communication parameters shared by the sharing unit,
wherein the sharing unit is configured to share a first communication parameter of the plurality of communication parameters with a higher priority over a second communication parameter,
wherein the first communication parameter is information for joining a same network with the external apparatus via the first communication, and
wherein the second communication parameter is information for communicating with the external apparatus in the network via the first communication.

2. The communication apparatus according to claim 1, wherein the sharing unit is configured to share the plurality of communication parameters with the external apparatus by requesting data from the external apparatus and receiving the plurality of communication parameters transmitted by the external apparatus in response to the request.

3. The communication apparatus according to claim 1, wherein the sharing unit is configured to share the plurality of communication parameters with the external apparatus by writing back the plurality of communication parameters received from the external apparatus to a sharing unit of the external apparatus.

4. The communication apparatus according to claim 1, wherein the sharing unit is configured to share the plurality of communication parameters with the external apparatus by transmitting the plurality of communication parameters to the external apparatus in response to a request for data from the external apparatus.

5. The communication apparatus according to claim 1, wherein the sharing unit is configured to share the plurality of communication parameters with the external apparatus by having the plurality of communication parameters transmitted to the external apparatus written back by a sharing unit of the external apparatus.

6. The communication apparatus according to claim 1, further comprising a control unit configured to control communication with the external apparatus via the connection unit,
wherein the sharing unit includes a recording area configured to be accessible from both the control unit and the external apparatus and record data in a configuration including a plurality of separate records,
wherein the sharing unit is configured to transmit a first record from among the plurality of separate records before a second record, and
wherein the control unit is configured to perform control to record the first communication parameter in the first record and the second communication parameter in the second record.

7. The communication apparatus according to claim 6, wherein the sharing unit is configured to transmit the first record before the second record in response to a request from the external apparatus.

8. The communication apparatus according to claim 1,
wherein the sharing unit is configured to record the plurality of communication parameters into a recording area of a sharing unit of the external apparatus in a data structure corresponding to a recording format of the recording area configured to record data in a structure including a plurality of separate records,
wherein the sharing unit is configured to record a first record from among a plurality of separate records into the recording area of the sharing unit of the external apparatus before a second record, and
wherein the first record includes the first communication parameter and the second record includes the second communication parameter.

9. The communication apparatus according to claim 8,
wherein the sharing unit is configured to read the first communication parameter and the second communication parameter from the recording area of the sharing unit of the external apparatus, and
wherein the sharing unit is configured to record the first record into the recording area of the sharing unit of the external apparatus before the second record.

10. The communication apparatus according to claim 1, wherein the connection unit is configured to form the network by using the second communication parameter.

11. The communication apparatus according to claim 1, wherein the connection unit is configured to join a network formed by a relay apparatus that is separate from the external apparatus and the communication apparatus, and
wherein the sharing unit is configured to share a communication parameter of the network formed by the relay apparatus with the external apparatus as the second communication parameter.

12. The communication apparatus according to claim 1, wherein the sharing unit is configured to share the plurality of communication parameters with the external apparatus by using power supplied from the external apparatus.

13. The communication apparatus according to claim 1, further comprising:
an imaging unit; and
a unit configured to share image data obtained by the imaging unit with the external apparatus via the first communication.

14. The communication apparatus according to claim 1,
wherein the first communication includes either a wireless LAN or Bluetooth, and
wherein the second communication includes either RFID or NFC.

15. A communication apparatus comprising:
a control unit;
a close-proximity communication unit configured to include a recording area accessible from the control unit and an external apparatus and share a plurality of communication parameters recorded in the recording area with the external apparatus via close-proximity communication; and
a wireless communication unit configured to establish connection with the external apparatus via a predetermined communication using the plurality of communication parameters shared with the close-proximity communication unit,
wherein the close-proximity communication unit is configured to perform control to transmit a first communication parameter of the plurality of communication parameters recorded in the recording area to the external apparatus with a higher priority over a second communication parameter in response to receipt of a read request from the external apparatus, and
wherein the first communication parameter is information for joining a same network with the external apparatus via the wireless communication unit and the second communication parameter is information for communicating with the external apparatus in the network via the wireless communication unit.

16. A communication apparatus comprising:
a control unit;
a close-proximity communication tag including a recording area configured to be accessible from the control unit and an external apparatus and record a plurality of communication parameters; and
a wireless communication unit configured to establish connection with the external apparatus via a predetermined communication,
wherein the control unit is configured to perform control to record a first communication parameter of the plurality of communication parameters in a record of higher order than that of a second communication parameter, and
wherein the first communication parameter is information for joining a same network with the external apparatus via the wireless communication unit, and the second communication parameter is information for communicating with the external apparatus in the network via the wireless communication unit.

17. A communication apparatus comprising:
a write unit configured to write a plurality of communication parameters into a close-proximity communication tag of an external apparatus; and
a wireless communication unit configured to establish connection with the external apparatus via a predetermined communication using at least a part of the plurality of communication parameters,
wherein the write unit is configured to perform control to record a first communication parameter of the plurality of communication parameters into the close-proximity communication tag before a second communication parameter, and
wherein the first communication parameter is information for joining a same network with the external apparatus via the wireless communication unit and the second communication parameter is information for communicating with the external apparatus in the network via the wireless communication unit.

18. The communication apparatus according to claim 17,
wherein the close-proximity communication tag of the external apparatus is configured to be accessible from a control unit of the external apparatus, and
wherein the control unit of the external apparatus is configured to start exclusive access control to the close-proximity communication tag according to a start of a write of the plurality of communication parameters to the close-proximity communication tag from the write unit.

19. A method for controlling a communication apparatus, comprising:
sharing a plurality of communication parameters for connecting to an external apparatus via a first communication with the external apparatus via a second communication different from the first communication; and
connecting to the external apparatus via the first communication using the shared plurality of communication parameters,
wherein a first communication parameter of the plurality of communication parameters is shared with a higher priority over a second communication parameter,
wherein the first communication parameter is information for joining a same network with the external apparatus via the first communication, and
wherein the second communication parameter is information for communicating with the external apparatus in the network via the first communication.

20. A non-transitory computer-readable storage medium storing computer executable instructions for causing a computer to execute a method for controlling a communication apparatus, the method comprising:
sharing a plurality of communication parameters for connecting to an external apparatus via a first communication with the external apparatus via a second communication different from the first communication; and
connecting to the external apparatus via the first communication using the shared plurality of communication parameters,
wherein a first communication parameter of the plurality of communication parameters is shared with a higher priority over a second communication parameter,
wherein the first communication parameter is information for joining a same network with the external apparatus via the first communication, and
wherein the second communication parameter is information for communicating with the external apparatus in the network via the first communication.
